(19) United States
(12) Patent Application Publication
(10) Pub. No.: US 2025/0052866 A1
(43) Pub. Date: Feb. 13, 2025

(54) IMPROVED WIDE-FIELD-OF-VIEW LIDAR

(71) Applicants: CENTRE NATIONAL DE LA RECHERCHE SCIENTIFIQUE, PARIS (FR); UNIVERSITE PARIS-SACLAY, GIF SUR YVETTE (FR)

(72) Inventor: Jean-Paul CROMIERES, ORSAY (FR)

(73) Assignees: CENTRE NATIONAL DE LA RECHERCHE SCIENTIFIQUE, PARIS (FR); UNIVERSITE PARIS-SACLAY, GIF SUR YVETTE (FR)

(21) Appl. No.: 18/722,587

(22) PCT Filed: Dec. 16, 2022
(86) PCT No.: PCT/EP2022/086515

§ 371 Date: Jun. 21, 2024

(30) Foreign Application Priority Data
Dec. 21, 2021 (FR) 2114176

(51) Int. Cl. G01S 7/481; G01S 7/4861; G01S 17/10; G01S 17/931

(52) U.S. Cl. CPC G01S 7/4816; G01S 7/4814; G01S 7/4861; G01S 17/10; G01S 17/931

(57) ABSTRACT

A lidar system based on measuring a time-of-flight, including: an emission device configured to emit light pulses towards a scene at an angle greater than or equal to 5°; a reception device including: o a photodetector configured to receive pulses reflected or backscattered by at least one element of the scene and to convert the pulses into an electrical signal, an amplification circuit configured to amplify the electrical signal, a processing unit for processing the amplified electrical signal, configured to digitize the amplified electrical signal and determine a distance from the at least one element based on the digitized amplified electrical signal, the amplification circuit including a transimpedance amplifier, a transformer including a primary and a secondary, a capacitor and an inductor arranged in series with the capacitor.

### FIELD

The present invention relates to the field of time-of-flight (TOF) lidars, and more particularly to lidars with a field-of-view greater than 5°. The focus here is on static lidars (with no moving mechanical parts) with low power consumption, small size and low cost. This type of lidar has applications in obstacle detection, for example.

### BACKGROUND

A lidar (Light Detection And Ranging) is a device used to measure distance by measuring the time of flight of a light pulse.

It emits a high-power, short-duration light pulse (typically a few ns), and recovers a reflected/backscattered pulse from an obstacle some time later. Knowing the propagation speed of the light, the distance is deduced from this delay, called the time of flight. It is calculated according to the formula:

$$d = \frac{c \cdot R}{2}$$

wherein c=3.10⁸ m/s is the speed of light, and R is the delay due to the distance d between the emitter and the obstacle. Thus, for an obstacle 1 m away, the delay is assumed to be 6.67 ns.

The lidar consists of:
an optical pulse emitter (laser diode or light-emitting diode), controlled by a logic component such as a microprocessor, microcontroller or FPGA
an optoelectronic receiver whose role is to convert the reflected pulse into an electrical signal while maintaining measurement quality, in particular by maximizing the measurement signal-to-noise ratio (S/N)
a device for processing the electrical signal provided by the receiver to deduce the distance to the obstacle. This device may be a time-to-distance converter (TDC), or a digital signal processing system based on a microprocessor, microcontroller or FPGA.

Typically, when using a laser diode emitter, the optical power emitted can be as high as a few tens of watts over a period of a few nanoseconds. The orders of magnitude of power received from echoes typically range from a few nanowatts to a few hundred milliwatts. The light background can vary from zero for complete darkness to 1 kW/m² (120 klux) for full sunlight. Thus, an illuminance of 10 W/m², corresponding to average artificial lighting illuminating a 5×5 mm² silicon photodiode, will generate a photogeneration current of about 500 μA, while full sunlight will generate a current of about 20 mA (taking into account the entire solar spectrum).

Lidars are used to measure distances, map surfaces and detect objects. There are several types of lidar:

Narrow-field 1 D lidar features a pulsed light beam with a small aperture (Field Of View—FOV). It measures the distance from a precise point, where the object is located. Optoelectronic components (beam-emitting diode, receiving photodiode) are then combined with optical components (lenses, filters, etc.) to collimate and focus the beams.

FIG. 1 shows a 1D lidar L0 according to the state of the art. It comprises an emission device DE0 for emitting light pulses toward a scene at a small angle (FOV), typically less than 3°. The emitting element EL0 is, for example, a laser diode or a light-emitting diode. Typically, a collimating optic (not shown) is coupled to the emitter to obtain a low divergence of the illumination beam.

The lidar L0 also comprises a reception device (or receiver) DR0 comprising a photodetector PD0 that can receive pulses reflected or backscattered by at least one element (Ei, index of the element i) of the scene and convert the reflected pulses into an electrical signal, and an amplification circuit CA0 that amplifies the electrical signal. Conventionally, the receiver (photodetector and amplification circuit) has an impulse response hr (t) that can be measured and/or calculated. Typically, an optical receiver (not shown) is coupled to the photodetector to obtain a low solid angle of reception, and thus to recover the useful light as a priority

A processing unit UT0 controls the emission, typically via a logic component of the microprocessor, microcontroller or FPGA type, digitizes the amplified electrical signal, and processes it to extract the useful information, that is, the presence of elements in the detection field and their respective distance.

Optoelectronic components (beam-emitting diode, receiving photodiode) are then often combined with optical components (lenses, filters, etc.) to collimate and focus the beams. These narrow-field (typically less than 3°), short-range 1D lidars are marketed for obstacle detection applications in lightweight applications for autonomous or semi-autonomous moving objects such as drones or robots in the broadest sense (autonomous vacuum cleaners and lawnmowers, radio-controlled vehicles with obstacle detection, etc.). They have supplanted the traditional ultrasonic rangefinders, whose field of view is much wider and whose first detected obstacle is not exactly known.

1D lidars have the advantage of being relatively compact and inexpensive, but have a major drawback in that their field of view is narrow, at less than 3° (Safran LRF3013, Benewake TF02). FIG. 2 shows a drone D equipped with a 1D lidar L0 according to the state of the art in descent action over uneven terrain: obstacle detection is uncertain due to the narrow field of view.

The need for obstacle detection requires a wide field of view, as shown in FIG. 3, wherein the drone D is equipped with a 3D lidar enabling it to detect obstacles as it lands.

Today, 3D lidars with scan technology are used to obtain a wide field. The pulse beam also has a small aperture, but is coupled with a mechanical scanning system to irradiate an entire portion of the space: several shots directed at different locations are required to produce a map. 3D lidars enable precise mapping of the environment using mechanical systems of varying complexity, or MEMS (Micro Electro Mechanic Systems). They are effective, but have the disadvantage of being oversized for light applications, in terms of:
Volume of data: precise mapping requires extensive processing of data, not all of which can be expected to be processed
Large physical footprint
High power consumption (more than 1 W in most cases)
Low measurement refresh rate (a few tens of Hz)

This is why, in the field of reversing radars that need to detect obstacles in a wide field of view, camera-based devices rather than lidars have supplanted or supplemented ultrasonic sensors. For collision avoidance, the wide field of an ultrasonic sensor is an advantage over traditional 3D lidar, which needs to be mounted on a turntable to scan a wide field. Additionally, ultrasonic sensors are easier to use because of the low propagation speed of acoustic waves compared with electromagnetic waves, which means that echo times are much longer and easier to measure. These are in particular used in a wide range of applications, such as vehicle collision avoidance, robotics, and detection of the presence of objects or living beings.

However, the characteristics of the wavelength and propagation speeds of acoustic waves mean that ultrasonic sensors have fundamental shortcomings:
high sensitivity to atmospheric and environmental conditions: humidity, rain, temperature and noise, and it is difficult to achieve ranges beyond one meter with reasonable sensitivity in these climatic conditions,
the presence of parasitic secondary lobes in the measurement field, with the risk of false detections,
insensitivity to low-roughness surfaces (less than a mm) viewed at high incidence (total reflection prevents detection).
difficulty in detecting fine objects, small dimensions or surfaces
slow measurement is a limitation to the detection of obstacles moving relative to the sensor

A lidar with the wide-field properties of ultrasonic sensors, illuminating a scene at a cone angle of more than 5°, or even 10° or 20°, would be able to scan a large portion of space and detect echoes from different elements/obstacles present in the scene or field of observation, with the possibility of a single pulse (no need for scanning). What is more, a wide FOV lidar that is virtually insensitive to high humidity and/or rain and that can detect a smooth painted surface at high incidence would have a competitive edge in anti-collision applications, which are still reserved for ultrasound. It could also be used for autonomous movement of robots or drones.

But the wide field is not lidar's natural domain. This is because the backscattered optical flux decreases with distance (d) to d⁻⁴ for small objects, instead of decreasing to d⁻² for a narrow field, which limits its range. The difference is in the density of incident light intensity. In a so-called “narrow field,” it is assumed that all incident energy is included on the surface of the obstacle (in other words, the surface of the obstacle is greater than the surface illuminated at the solid angle): the obstacle receives all the energy from the emitter. Each point on the obstacle then backscatters energy toward the receiver according to a d⁻² law. In the case of a wide field, the obstacle is totally included in the illumination cone: the obstacle receives only part of the emitter's energy according to a d⁻² law, and backscatters this energy toward the receiver also according to a d⁻² law, with an overall energy on the receiver in d⁻⁴ of the emitter's energy. Additionally, large objects in the background obscure small ones in the foreground. Centimeter resolution is more difficult to achieve, and costs are higher than for ultrasonic sensors.

In addition, a wide field of view poses problems for the receiving device.

The most suitable and widely used receiver circuit is the Trans Impedance Amplifier (TIA), associated with a photodiode PD0. These elements are well known to professionals. The TIA circuit, based on operational amplifiers, can be complex. It is configured to transform the current from the photodetector into an electrical voltage.

In its most basic form, the TIA-type amplification circuit CA0 consists of a resistor R0 and an operational amplifier Amp0. Its structure is shown in FIG. 4.

Considering the ideal components:
The photodiode PD0 transforms the luminous flux into a photogeneration current iₚₕ₀.
The TIA transforms the current iₚₕ₀ into voltage according to the relationship:

$${V}_{s 0} = - {R}_{0} {i}_{ph 0} .$$

The value of the resistor R₀ sets the amplifier gain. The TIA sensitivity is linked to this value.

The most widely used photodetector is a PIN-type photodiode, which is more reliable and simpler to implement than an avalanche photodiode.

The current from the photodiode can be described by the relationship:

$${i}_{ph 0} ( t ) = S \cdot {∅}_{e} ( t ) + {I}_{0} + {i}_{{n}_{ph 0}} ( t )$$

wherein:
S is the sensitivity of the photodiode, of the order of 0.6 A/W,
Øₑ(t) is the received candle power,
I₀ is the sum of the photodiode's reverse static currents (saturation current, black current),
iₙ_{ₚₕ₀}(t) represents the sum of the photodiode's intrinsic noise (mainly shot noise).

The captured light power Øₑ(t) can also be made up of a dynamic part φₑ(t) such as the reflected pulse and a static part caused by a light background Øₑ₀, caused by the sun for example. The relationship is then written:

$${i}_{ph 0} ( t ) = S \cdot ( {φ}_{e} ( t ) + {∅}_{e 0} ) + {I}_{0} + {i}_{{n}_{ph 0}} ( t )$$

By way of example, a silicon PIN photodiode generates around 600 mA/W. The photodiode is usually followed by a transimpedance amplifier whose gain is usually a compromise between the desired bandwidth and the sensitivity (detection capability) of the sensor. It can also be limited by the strength of the photodiode's reverse static currents.

In reality, the operational amplifier Amp0 and the resistor R₀ are sources of noise. FET technology is most often used for operational amplifiers, due to its attractive characteristics of very low noise current, of the order of femtoA/\sqrt{Hz}.

Under these conditions, it is known that the current noise added by the TIA mainly originates from the resistance R₀, whose noise spectral density is:

$${∅}_{n} = \frac{4 kT}{{R}_{0}}$$

where k=1.38. 10⁻²³ J·K⁻¹ is Boltzmann's constant, and T the temperature in Kelvins.

This leads to a noise current source iₙ(t) parallelized to the signal source iₚₕ₀. The signal-to-noise ratio S/N is then proportional to \sqrt{R₀} (see, for example, Wikipedia: “Transimpedance noise considerations”).

In terms of sensor sensitivity and measurement signal-to-noise ratio S/N, it is therefore advisable to use a high resistance R₀, leading to high gain.

During detection, ambient brightness is amplified in the same way as optical echo signals. We have already mentioned the very different orders of magnitude between the currents generated by echo pulses (a few MA for an echo of a few MW) and that induced by ambient brightness (a few tens of mA for a 5×5 mm² silicon photodiode detecting the entire solar spectrum).

To limit the photogeneration current typically induced by the sun, which can lead to TIA saturation, an optical filter can be placed just above the photodiode surface. It can be the colored filter integrated into the photodiode proposed by manufacturers (broad spectrum of the order of 300 nm), or an interference filter (narrow spectrum of the order of 10 nm and angular tolerance of less than 3°, which presents a major directivity drawback).

Typically considering an average solar power of 1 W·m⁻²·nm⁻¹ around a working wavelength of 900 nm illuminating a PIN photodiode of dimensions 5 mm×5 mm, a quick calculation gives the TIA output voltage values (see Table I below) for two values of R₀:
R₀=10 kΩ corresponding to a conventional value in TIAs used for state-of-the-art Lidars, achieving a sensitivity/noise/bandwidth compromise.
R₀=1 MΩ

TABLE I

| | output | | | |
|---|---|---|---|---|
| | voltage for | | Theoretical Vs0 | |
| | echo signal | Theoretical Vs0 for sun | for sun - 10 nm | |
| R₀ | 1 μW | 300 nm bandpass filter | bandpass filter | |
| 10kΩ | 10 mV | 70 V | 2.1 | V |
| 1MΩ | 1 V | 6920 V | 2100 | V |

A typical TIA supply voltage is 3 to 5 V. Any higher theoretical output voltage Vs0 will saturate it. It follows that:
As it stands, full-sunlight operation can only be envisaged using a low-sensitivity TIA equipped with a resistor where R₀=10 kΩ and a very fine interference filter positioned upstream of the photodiode.
As it stands, full-sunlight operation cannot be envisaged when using the low-noise, high-sensitivity TIA equipped with a resistor where R₀=1 MΩ.

As a result, the sensor's performance in full sunlight is antagonistic to the use of a high-sensitivity TIA. This is a major limitation for outdoor lidars. Furthermore, the addition of an interference filter to a wide-field-of-view lidar is not an option due to the difficulties involved in its implementation, particularly its small aperture angle.

Photodiode average current compensation solutions are proposed in the literature and by component manufacturers specializing in time-of-flight detection.

One of these solutions often consists in subtracting the average current from the ambient illuminance. An example component, the MAX 40658 produced by Maxim Integrated, illustrates this method. Its effectiveness is limited by the saturation of the compensation circuit and leads at the very least to the use of a narrow-band optical filter (interference filter) to minimize the power of the sun on the photodiode, with no guarantee of operation at the highest luminosities. But the interference filter is not compatible with wide-field detection, as it only works over an angular range close to normal.

Another solution was proposed in 2020 by Juha Kostamovaara et al. in the publication “A wide dynamic range laser radar receiver based on Input Pulse-shaping technique”, IEEE transactions on circuits and systems-I: regular papers, Vol 67, No. 8, 2020. The authors use an inductor to short-circuit the average current generated by ambient lighting. However, this method has the disadvantage of drastically limiting the amplifier's gain capacity by diverting the photogeneration current.

One aim of the present invention is to overcome some of the aforementioned drawbacks by offering a wide-field-of-view lidar with improved sensitivity and made insensitive to ambient lighting, this being achieved by adding a component to the reception device.

### SUMMARY

The present invention relates to a lidar system based on measure time-of-flight, comprising:
an emission device configured to emit light pulses toward a scene at an angle greater than or equal to 5°
a reception device comprising:
a photodetector configured to receive pulses reflected or backscattered by at least one element (Ei) of the scene and to convert said pulses into an electrical signal,
an amplification circuit configured to amplify said electrical signal,
a processing unit for processing said amplified electrical signal, configured to digitize the amplified electrical signal and determine a distance (di) from said at least one element based on said digitized amplified electrical signal.

The amplification circuit comprises a transimpedance amplifier, a transformer comprising a primary and a secondary, a capacitor and an impedance arranged in series with the capacitor, the primary of the transformer being connected to an anode of the photodetector, the secondary being connected to said capacitor, said capacitor being connected to an input of said transimpedance amplifier.

According to one embodiment, the frequency operating range of the transformer includes the [10 MHz; 350 MHz] band.

According to one embodiment, a transformation ratio equal to the ratio of the number of turns of the secondary to the number of turns of the primary is strictly greater than 1.

According to one embodiment, the capacitor C and the inductor L satisfy the relationship:

$$( L + {n}^{2} {L}_{p} ) C > {L}_{p} {C}_{ph}$$

with Lₚ the transformer primary inductance, Cₚₕ the photodiode transition capacitance, n the transformation ratio defined by:
nₛ/nₚ with nₚ and nₛ the number of primary and secondary turns, respectively.

According to one embodiment, the inductor satisfies the relationship:

$$L > \frac{{n}^{2} {L}_{p}}{{L}_{p} {{C}_{ph} ( 2 π {f}_{i \_ b} )}^{2} - 1}$$

where:
nₛ/nₚ with nₚ and nₛ the number of primary and secondary turns, respectively,
Lₚ the inductor of the primary of the transformer, Cₚₕ the photodiode transition capacitance, fib the minimum frequency of interest.

According to one embodiment, said inductor verifies the relationship:

0.5Ls<L<2Ls

where L is the inductor and Ls is the secondary inductor of the transformer

According to one embodiment, the capacitor C satisfies the relationship

$$\frac{10}{{n}^{2}} {C}_{ph} < C < \frac{500}{{n}^{2}} {C}_{ph}$$

with Cph the photodiode transition capacitor.

According to one embodiment, the reception device further comprises a so-called damping resistor between the photodetector and the transformer primary.

The following description presents several examples of the device of the invention: these examples are not limiting with respect to the scope of the invention. These examples of embodiments present both the essential features of the invention as well as additional features related to the embodiments considered.

### BRIEF DESCRIPTION OF THE FIGURES

The invention will be better understood and other features, purposes and advantages thereof will become apparent in the course of the detailed description which follows and with reference to the appended drawings, given by way of non-limiting examples and wherein:

The aforementioned FIG. 1 shows a low field-of-view lidar according to the state of the art.

The aforementioned FIG. 2 shows a drone equipped with a 1D lidar according to the state of the art in descent action over uneven terrain.

FIG. 3 shows the benefits of wide-field lidar for obstacle detection during drone landing.

FIG. 4 shows a simplified amplification circuit for lidar according to the state of the art.

FIG. 5 shows a wide-field-of-view TOF lidar according to the invention.

FIG. 6 shows an amplification circuit according to the invention.

FIG. 7 shows an embodiment of the lidar reception device according to the invention with a basic transimpedance amplifier circuit.

FIG. 8 shows the equivalent diagram of a photodiode.

FIG. 9 shows a circuit showing the concept of noise gain.

FIG. 10 shows the equivalent diagram of the reception device according to the invention, comprising a photodiode, a transformer, an additional impedance Z and a transimpedance amplifier.

FIG. 11 shows the equivalent diagram of FIG. 10, with the elements connected to the primary attached to the secondary of the transformer.

FIG. 12 shows an example of an amplification circuit according to the invention, wherein an inductor L is added in series with the capacitor C.

FIG. 13 shows an overall diagram with an impedance Z including a capacitance C and an inductor L.

FIG. 14 shows the asymptotic diagram of signal gain (A) and noise gain (B) for the circuit shown in FIG. 13.

FIG. 15 shows the asymptotic diagram of signal gain (A) and noise gain (B) for three values of f_{M} (f_{M1}, f_{M2}, f_{M3}).

FIG. 16 shows the equivalent circuit diagram of FIG. 13, wherein the noise voltage source has been deliberately omitted.

FIG. 17 shows an embodiment of the reception device according to the invention comprising a resistor in series with the photodiode.

FIG. 18 shows various simulated signals.

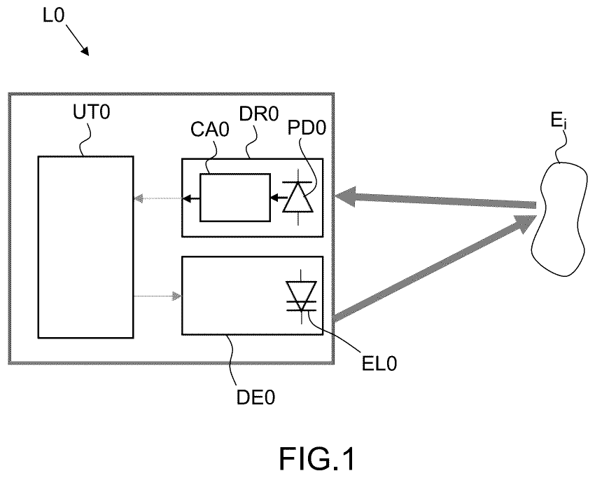

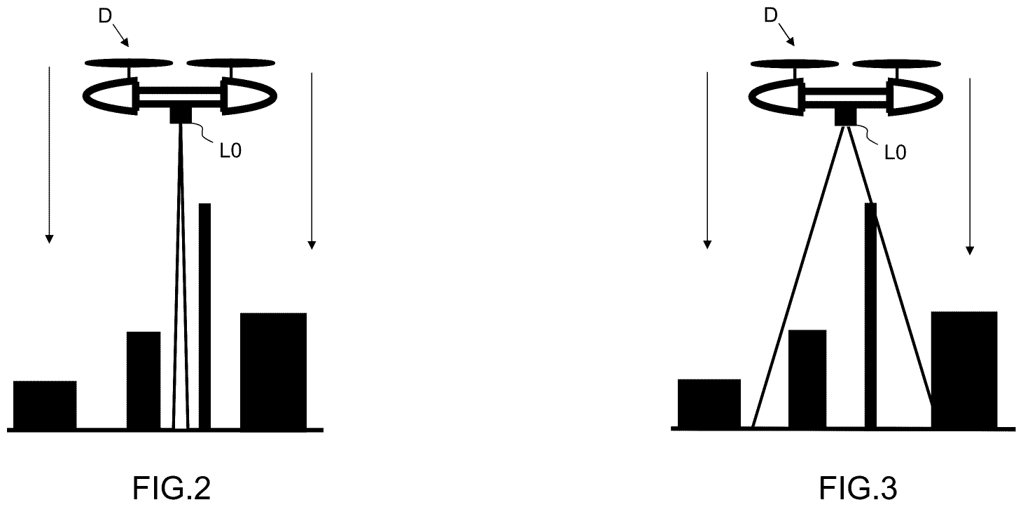

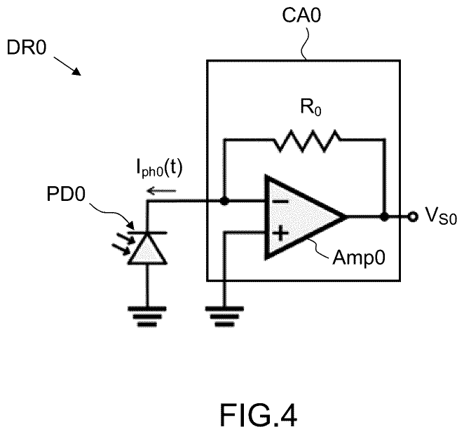

### DETAILED DESCRIPTION

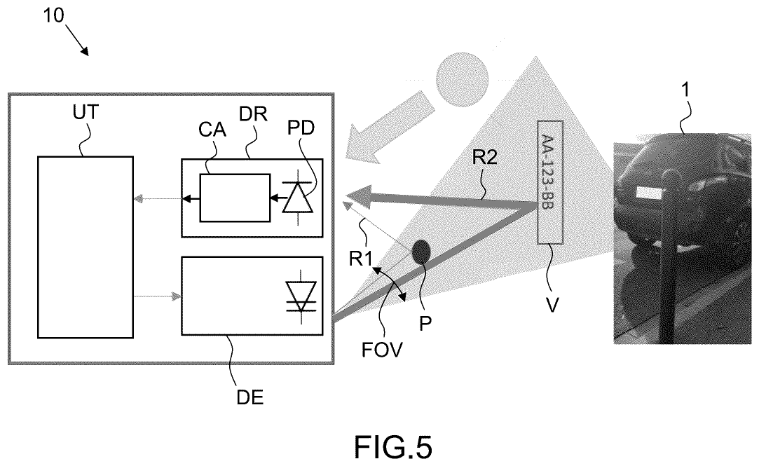

A wide FOV TOF lidar 10 according to the invention is shown in FIG. 5. It includes an emission device DE configured to emit light pulses toward a scene at an angle (FOV) greater than or equal to 5°, preferentially 10°. The emitting element is, for example, a laser diode or a light-emitting diode. The choice of wavelength for a lidar according to the invention is wider than for a narrow-field lidar, because for eye safety, using a wide field greatly limits the risks. Preferentially, the illumination wavelength is chosen close to the detector's maximum sensitivity in order to optimize reception. According to one embodiment, the desired wide field of view is obtained by using the natural divergence of the transmitter (around ten to several tens of degrees, depending on the components and transmission axes), which has the advantage of eliminating the need for optics and therefore saving space and simplicity. In another embodiment, an optic coupled to the emitter enables the desired FOV to be obtained.

The lidar 10 also comprises a reception device (or receiver) DR comprising a photodetector PD configured to receive pulses reflected or backscattered by at least one element (Ei, index of the element i) of the scene and to convert the reflected pulses into an electrical signal, and an amplification circuit CA configured to amplify the electrical signal. The detector can be used without optics or coupled with optics to adapt the detection field.

A processing unit UT controls the emission, typically via a logic component of the microprocessor, microcontroller or FPGA type, digitizes the amplified electrical signal, and processes it to extract the useful information, that is, the presence of elements (Ei, index of the element i) in the detection field and their respective distance (distance di).

In the example shown in FIG. 5, there are two elements E1 and E2 in the detection field, a pole P and a vehicle V, respectively. The initial pulse Ii is emitted at instant t=0, and the photodetector receives, at instant t1, a first pulse Ir1 from the backscatter of the pole P and, at instant t2, a second pulse Ir2 from the backscatter of the vehicle V. The delay associated with the distance d₁ between the emitter and the pole P is referred to as R₁, while the delay associated with the distance d₂ between the emitter and the vehicle V is referred to as R₂.

The detector also receives ambient light such as sunlight. For the example of a reversing lidar according to the invention mounted on a vehicle V, photo 1 shows the scene illuminated by the lidar on the vehicle V. In general, the lidar according to the invention can be mounted on any moving object: a car, a drone, a robot, a visually impaired person's walking stick, etc. For it to work properly, the lidar must detect the presence of the pole P and determine its distance d1 without being impeded by the backscatter from the vehicle V.

According to another example, the lidar is static and detects the presence of static or moving objects.

A first consequence of opening the field is the spatial spreading of the emitted energy, leading to less illumination of obstacles, which in turn provide lesser echoes, which are more difficult to measure than in the case of a focused or collimated beam emission.

A second consequence of opening up the detection field is the higher probability of finding a strong emissive source, such as the sun.

Last but not least, the proximity of obstacles means short echo times, which on the face of it requires fast detection electronics.

The focus here is on detecting lidar signals with a frequency of interest in the [10 MHz, 350 MHz] band. This frequency band is linked, inter alia, to the shape of the pulse and the separation of the return pulses to be measured (e.g. 1 m apart).

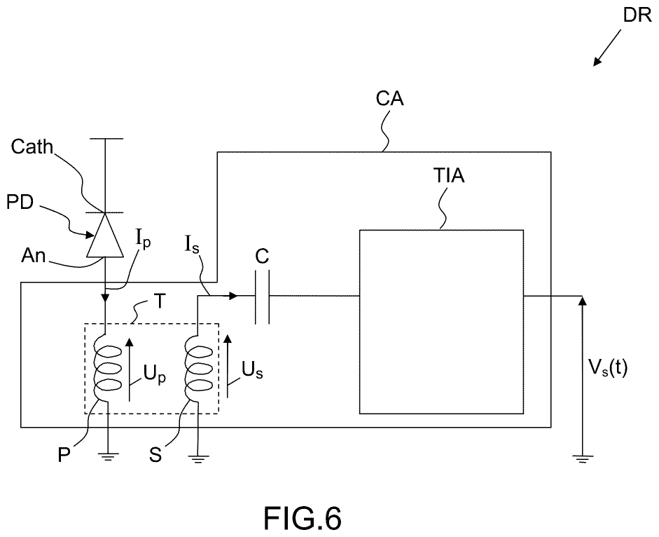

The aim of the invention is to get rid of the parasitic signal generated by the presence of ambient illumination, that is, to cancel the DC component of the photogeneration current while maintaining high sensitivity and a low noise level. To this end, the amplification circuit CA of the lidar 10 according to the invention comprises a transimpedance amplifier circuit TIA, a transformer T comprising a primary P and a secondary S and a capacitor C as shown in FIG. 6. The photodetector typically has an anode An and a cathode Cath. The transimpedance amplifier circuit TIA is a state-of-the-art circuit suitable for lidar applications. The primary P of the transformer is connected to the anode An of the photodetector, while the secondary S is connected to the capacitor C, which in turn is connected to an input of the transimpedance amplifier.

Recall that the primary P and secondary S circuits of a transformer are, to a first approximation, linked by the relationship:

$$\frac{{U}_{s}}{{U}_{p}} = \frac{{I}_{p}}{{I}_{s}} = \frac{{n}_{s}}{{n}_{p}} = n ,$$

with Up and Us primary and secondary voltages, respectively, Ip and Is the primary and secondary currents, respectively, as shown in FIG. 6, nₚ and nₛ the number of primary and secondary turns, respectively, and n the transformation ratio.

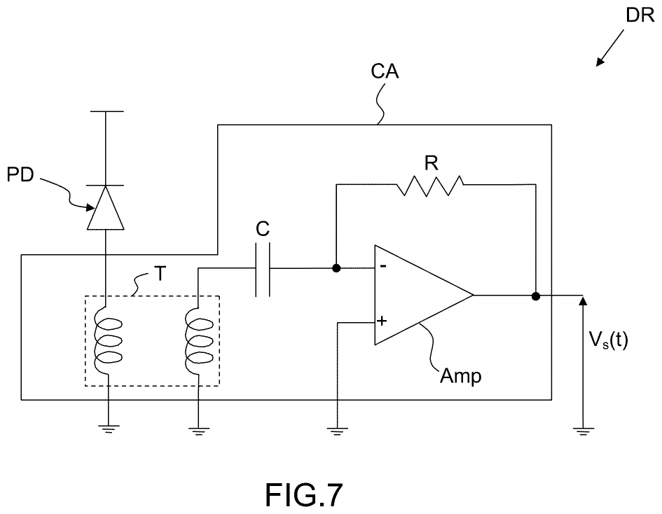

An example of an amplification circuit according to the invention, with a basic transimpedance amplifier comprising an amplifier Amp and a resistor R, is shown in FIG. 7. Of course, the invention is compatible with any more complex TIA used for lidar detection, comprising several amplification components (operational amplifiers, transistors).

The transformer's operating principle lies in the conversion of a current at its primary, in this case the photodiode current iₚₕ(t) into a magnetic field B(t), which in turn is converted back into an electric field E(t), and thus into a voltage Vs(t) at the secondary of the transformer. The photodiode current was described above:

$${i}_{ph} ( t ) = S \cdot ( {φ}_{e} ( t ) + {∅}_{e 0} ) + {I}_{0} + {i}_{{n}_{ph}} ( t ) \qquad ( 1 )$$

I₀ sum of reverse static currents of the photodiode (saturation current, black current), iₙ_{ₚₕ} (t) sum of intrinsic photodiode noise (mainly shot noise).

Preferentially, the photodetector is fitted with a colored filter, for example with transmission between 750 nm and 1100 nm (emission at 900 nm), or Δλ=350 nm. Recall that an interference filter cannot be used because its small angular field (3° maximum) is not compatible with the wide detection field of the lidar according to the invention.

By way of example, we determine the photogeneration current iₚₕₛ generated by direct sun with a power density or irradiance Irs of 0.89 W/m²/nm, the photodetector (PIN diode with detection area A=25 μm×25 μm) coupled to a colored filter with a passband of 350 nm:

$${i}_{phs} ( t ) = S \cdot A \cdot {I}_{rs} \cdot Δλ = 0 , 6 \times {25.1}^{- 6} \times 0.89 \times 350 = 0.52 mA$$

It is known that the electric field is based on the derivative of the magnetic field induced by iₚₕ(t). As a result, the transformer voltage and current depend only on variations in iₚₕ(t). The voltage from the TIA will be of the form:

$$Vs ( t ) = k \cdot \frac{d}{dt} {φ}_{e} ( t )$$

Without characterizing the coefficient k, it is established here that all static components of the photodiode current iₚₕ(t) are eliminated at the transformer secondary:
the intrinsic reverse parasitic photodiode currents I₀ (saturation current, black current),
photogenerated currents due to any light source, weak or intense (sun).

The addition of a capacitor C is linked to the issue of noise reduction, as explained below.

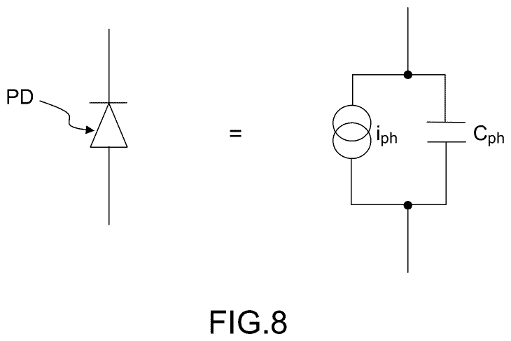

It is a well-known fact that the transimpedance amplifier only fulfills its role ideally if the current source connected to its input is ideal and has an infinite output impedance. A real current source has a finite output impedance. It can be resistive, inductive or capacitive, or a mix of several elements. In particular, a photodiode can be likened to a current source with a capacitive output impedance Zₛ=Cₚₕ. The equivalent diagram of a photodiode is shown in FIG. 8.

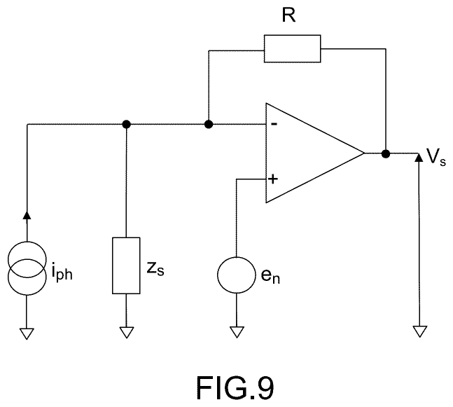

Like any electronic system, the TIA intrinsically generates noise symbolized at its inputs as a single source of voltage noise and a single source of current noise, whose spectral densities can be considered to be constant for the frequencies of interest. Since FET (Field Effect Transistor) amplification technology adds little current noise, and the high feedback resistance R of the TIA also adds little noise, we are interested here in the source of voltage noise, relative to the input. The TIA, whatever its electronic structure, then behaves like an amplifier in relation to its noise voltage source, by a value conventionally called “noise gain”, shown in FIG. 9.

The noise gain G is defined as:

$$Gn = {Vs}_{n} / {e}_{n} = 20 \cdot log [ 1 + R / Zs ]$$

With Vsₙ the output voltage with iₚₕ=0.

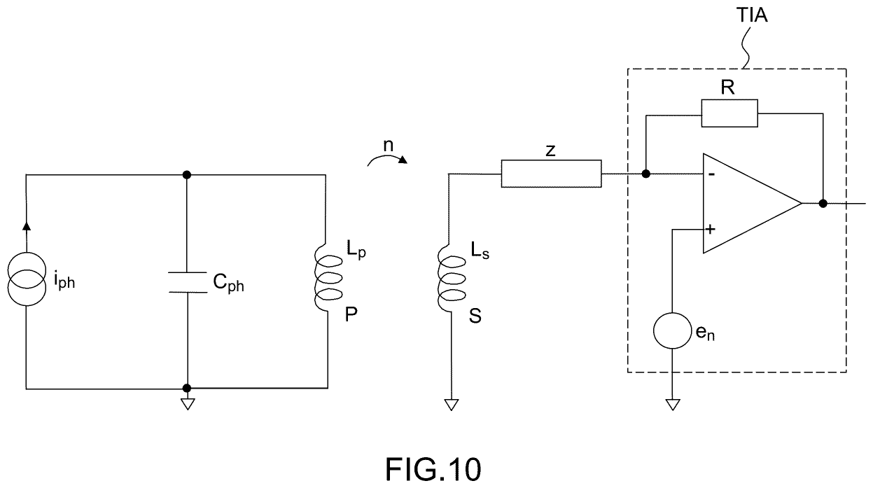

All the spectral components of noise must be considered here, from DC (offset voltage) to infinite frequencies. Since the impedance of a transformer is a low-value DC resistance, the use of a high-value TIA gain resistance leads to a high noise gain with which even a low-value offset voltage (typically a few tens of microvolts) leads to TIA saturation. It is therefore advisable to add an impedance Z in series with the secondary of the transformer to increase the branch impedance of the circuit and thus limit the noise gain. FIG. 10 shows the photodiode PD (iₚₕ, Cph)/transformer T (primary P with inductance Lp, secondary S with inductance Ls)/additional impedance Z/transimpedance amplifier TIA equivalent diagram. The TIA is shown here in its basic version, but it is understood that the reasoning applies to a more complex TIA circuit.

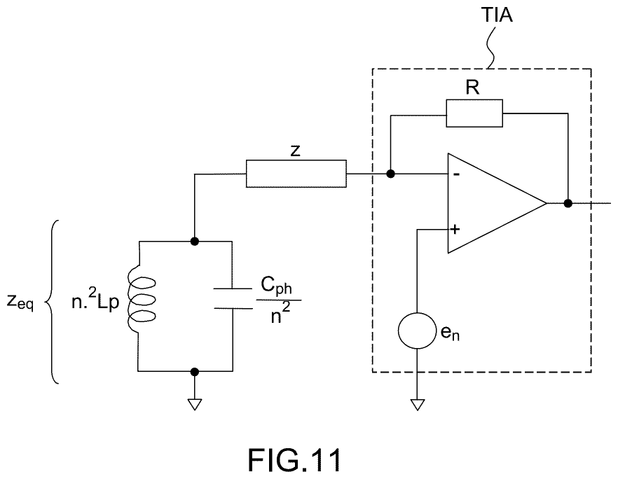

FIG. 11 shows the photodiode/transformer/Z/TIA equivalent diagram, with the elements connected to the primary attached to the secondary of the transformer. Zeq is the impedance of the transformer loaded by the photodiode. It should be noted that the source iₚₕ is not included for simplicity's sake. The formula for the noise gain G of the circuit according to the invention in FIG. 11 is written:

$$Gn = 20 \cdot log [ 1 + R / ( Zeq + Z ) ] \qquad ( 2 )$$

To avoid adding any additional thermal noise (Johnson noise), the impedance Z should be designed using purely reactive components (inductor, capacitor), namely limiting the use of resistive elements.

An essential component of Z is the capacitor C placed between the TIA and the transformer T. Its role is to minimize the low-frequency gain (particularly DC) that would result from a system composed solely of the AOP (Amp)/resistor R/transformer T assembly (for the simplified case of an operational amplifier-type amplification component, but this remains valid for a more complex amplification circuit, e.g. with several operational amplifiers). In fact, without this capacitor, this assembly would behave like a non-inverting amplifier with infinite gain with respect to the TIA offset voltage, resulting in saturation.

However, an impedance Z made up of a single capacitor is not optimal, as the overall impedance achieved Zeq+Z inevitably tends towards 0 at high frequencies, resulting in higher noise gain at these frequencies.

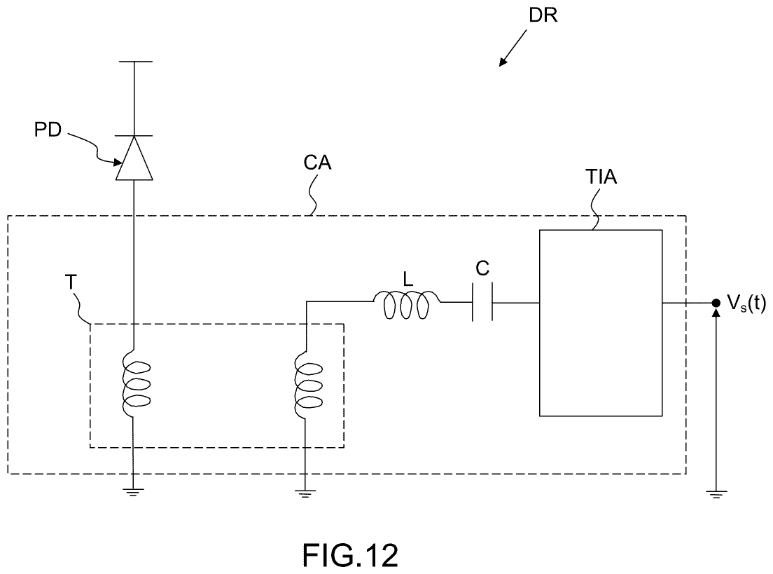

Thus, in the amplification circuit CA according to the invention, another component of Z is added, namely an inductor L placed in series with the capacitor C, as shown in FIG. 12. This is a way of raising the impedance Z at high frequencies, thus lowering the noise gain at these frequencies. The impedance L is an additional impedance different from the impedance Ls of the secondary of the transformer. The respective position of the impedance and the capacitance, arranged in series between the amplifier input and the transformer secondary, is irrelevant.

The structure of the amplifier circuit as claimed (T+C+L+TIA) therefore solves two problems. The gain resistance limit is lifted, as the various parasitic DC currents are filtered out. It is then possible to consider a sensor with very high gain (high resistance R) and improved detection capability. The sensor is virtually insensitive to ambient lighting. It is then possible to detect obstacles with direct sun. This makes it ideally suited to the use of a wide FOV lidar.

A fundamental characteristic of the transformer for use in the circuit according to the invention is the non-saturation of its magnetic circuit by the direct current generated, in particular by the sun. Saturation of the magnetic core would distort the useful signal or even render it non-transmissive, with the coefficient k moving toward 0. The distortion of the useful signal leads to non-linearities, with consequent limitations in signal processing In order to minimize non-linearities, it is advisable to choose a transformer capable of carrying currents ten times greater than the photogeneration current due to the direct sunlight. Assuming full sunlight, with a photogeneration current of 0.52 mA, the transformer's rated operating current must be greater than or equal to 5 mA.

The information-carrying phenomena involved in time-of-flight measurement (echo rise time, echo pulse width) are in the dozen nanosecond range. This leads to an equivalent frequency of

$$\frac{0.35}{10 \times {10}^{- 9}} = 35 MHz .$$

This frequency is very roughly the limit of the low cut-off frequency that the transformer T must have. The low cut-off frequency of the transformer is chosen to be lower, of the order of tens of MHz or a MHz.

Similarly, the high cut-off frequency of the transformer can be roughly characterized. It is necessary on the face of it to measure and separate events on nanosecond time scales. This leads to an equivalent frequency of

$$\frac{0.35}{1 \times {10}^{- 9}} = 350 MHz .$$

The high cut-off frequency of the transformer is preferentially chosen to be greater than this value.

As a result, a radio-frequency transformer is chosen whose bandwidth preferentially includes the 10 MHz to 350 MHz range. These transformers also have the advantage of being small in volume (the volume occupied by a transformer is inversely related to its operating frequencies).

Conventionally, the transformation ratio is expressed in voltage: a step-up transformer has a transformation ratio n greater than 1. In the lidar application of the invention, in addition to suppressing the DC component, the aim is to amplify the useful current. If a current Iₚ is injected into the primary of the step-up transformer, the secondary current will have the value

$${I}_{s} = \frac{1}{n} \cdot {I}_{p} .$$

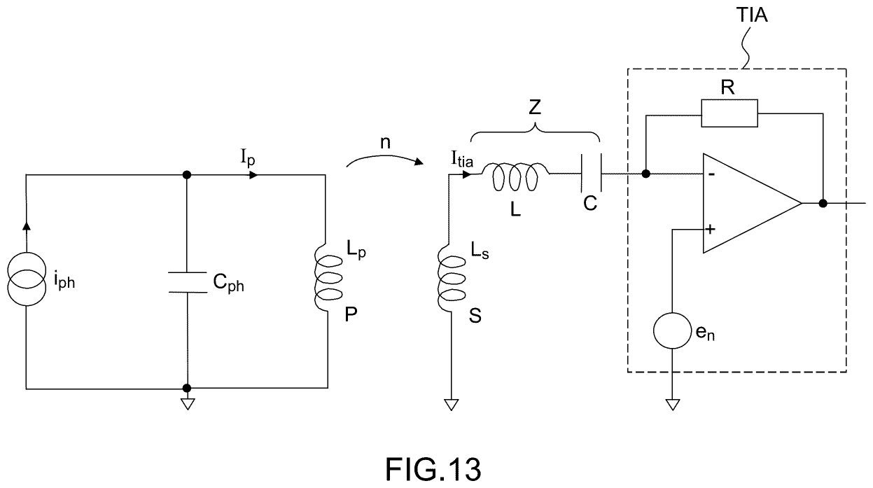

The notion of noise gain was explained above. This is limited by the addition of an impedance Z comprising a capacitor C in series with an inductor L, and optionally a resistor Rad also in series (not shown in the diagrams). An overall diagram with an impedance Z including a capacitor C and an inductor L is shown in FIG. 13. The current leaving the secondary is called Is=Iₜᵢₐ.

From formula (1) and the equivalent diagram in FIG. 13, the inventors have determined the following characteristics of the noise gain Gn.

The noise gain reveals three resonant frequencies:

$${f}_{LC} = \frac{1}{2 π \sqrt{( L + {n}^{2} {L}_{p} ) C}} :$$

series resonance frequency L, n²Lₚ, C resulting in maximum noise gain

$${f}_{m} = \frac{1}{2 π \sqrt{{L}_{p} {C}_{ph}}} :$$

parallel resonance frequency Lₚ, Cₚₕ resulting in minimum noise gain

$${f}_{M} ∼ \frac{1}{2 π \sqrt{\frac{L \cdot {L}_{p}}{L + {n}^{2} {L}_{p}} {C}_{ph}}} :$$

parallel resonance frequency of an equivalent inductance dependent on L, Lₚ and n, and on Cₚₕ resulting in maximum noise gain
f′ₘ is a corner frequency dependent on R, L, Lₚ, of the order of magnitude above a GHz, well above the frequencies of interest.

Because of the formulas, we necessarily have fₘ<f_{M}.

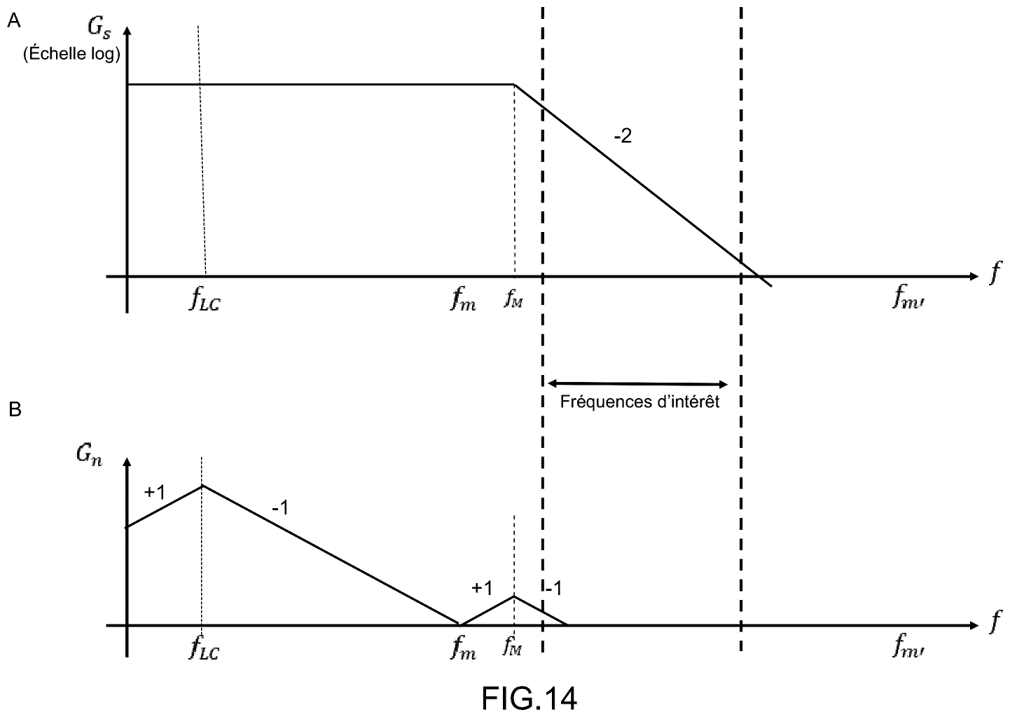

To optimize the measurement signal-to-noise ratio, the noise gain at the frequencies of interest should be minimized. With Cph imposed (which should be as low as possible), L and Lp are determined so that f_{M} is lower than the frequencies of interest. The asymptotic noise-gain diagram Gn corresponding to the circuit in FIG. 13 is shown in FIG. 14, B.

As a reminder:

Ls=n²Lₚ

The slopes are:
−20 db/dec (−1) for f_{Lc}«f<fₘ
+20 db/dec (+1) for fₘ<f<f_{M}
−20 db/dec (−1) for f_{M}<f<fₘ,

A first element for minimizing Gn is to shift the resonance f_{LC} to low frequencies, namely f_{LC}«fₘ, hence:

$$( L + {n}^{2} {L}_{p} ) C > {L}_{p} {C}_{ph} \qquad ( 3 )$$

Lₚ is the transformer primary inductance, Cₚₕ is the photodiode transition capacitance, n is the transformation ratio.

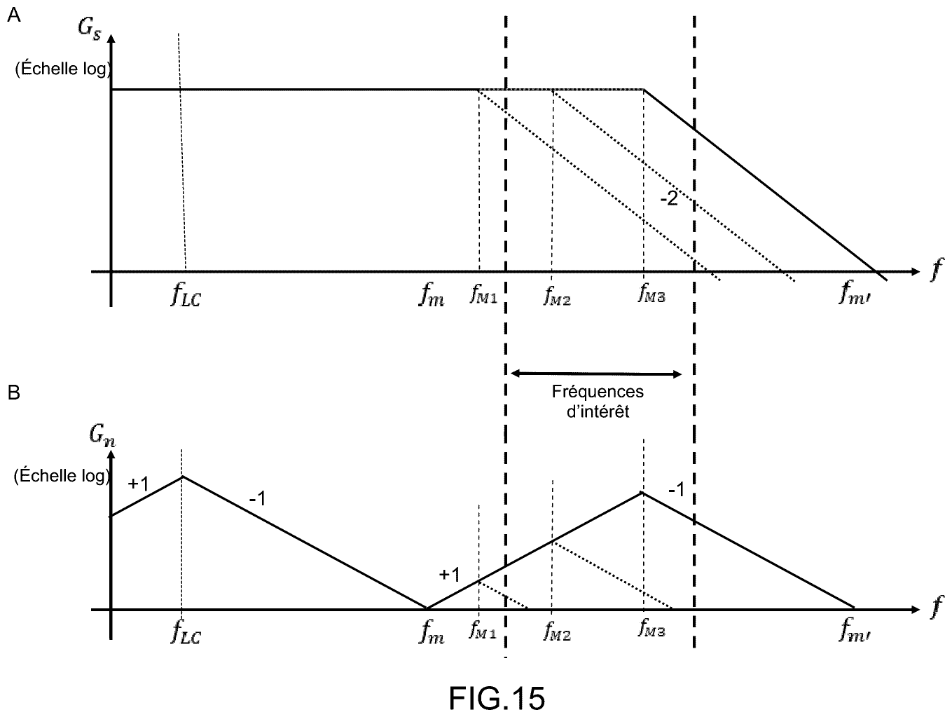

A second factor in decreasing noise gain at frequencies of interest is bringing the frequency f_{M}, controlled in part by L, closer to the frequency fₘ, determined by L_{S} and Cₚₕ. Indeed, as the frequency f_{M} moves further away from fₘ, the noise gain increases in the frequency range of interest, as shown in FIG. 15, B, which shows the asymptotic noise gain diagram for three different values of f_{M} (f_{M1}, f_{M2}, f_{M3}).

A third factor reducing noise gain at frequencies of interest is the positioning of the maximum noise gain at a frequency lower than the minimum frequency of interest.

From the circuit shown in FIG. 13, considering that the noise source eₙ is random in nature, generating white noise of constant spectrum, it is established that the noise intensity I_{TIA_noise} (iₚₕ=0) at the frequencies of interest is approximately equal to:

$${I}_{{TIA}_{bruit}} ( f ) \sim \frac{{e}_{n}}{R} \frac{1}{[ 1 + {( j \frac{f}{{f}_{M}} )}^{2} ] j \frac{f}{{f}_{R}}} for {f}_{M} < f < {f}_{m ′} \qquad ( 4 )$$

$$with {f}_{R} = \frac{R}{2 π ( L + {n}^{2} {L}_{p} )}$$

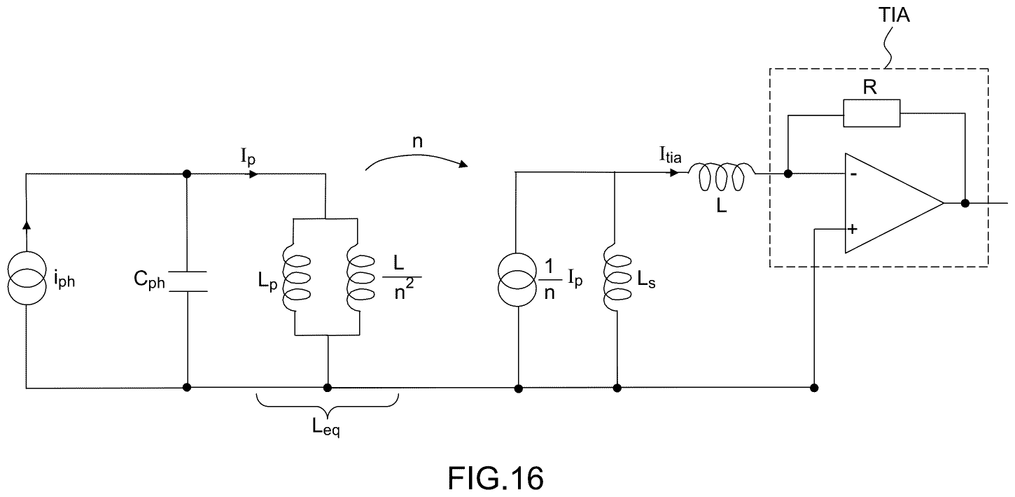

The dipole Z comprising L and C reduces noise gain but also impacts signal gain. From the diagram in FIG. 13, we can deduce the small signal diagram in FIG. 16, which allows us to describe the circuit by disentangling the primary and secondary of the transformer. The noise voltage source has been deliberately omitted, allowing the signal gain to be calculated, and the capacitor C has been omitted from the reasoning (resonance frequency generated with very low L and Ls compared to the frequencies of interest).

The effects of the capacitor C are not taken into account, as this acts mainly for frequencies well below fₘ, outside the frequency band of interest. From the diagram in FIG. 16, the asymptotic signal gain diagram Gs shown in FIG. 14, A and FIG. 15, A is determined for three different values of f_{M} (f_{M1}, f_{M2}, f_{M3}).

Studying the signal gain shows a cut-off frequency

$${f}_{0} \sim \frac{1}{2 π \sqrt{\frac{L . {L}_{p}}{L + {n}^{2} {L}_{p}} {C}_{ph}}} = {f}_{M} .$$

The simplified intensity formula I_{TIA_signal} is given by:

$${I}_{{TIA}_{signal}} ( f ) = \frac{1}{n} . {I}_{ph} . \frac{{n}^{2} {L}_{p}}{L + {n}^{2} {L}_{p}} . \frac{1}{1 + {( j \frac{f}{{f}_{M}} )}^{2}} for {f}_{M} < f < {f}_{m ′} \qquad ( 5 )$$

Calculating the signal-to-noise ratio in the frequency range of interest gives:

$$\frac{{I}_{{TIA}_{signal}}}{{I}_{{TIA}_{bruit}}} ( f ) = n . \frac{{I}_{ph}}{{e}_{n}} \frac{1}{{jC}_{ph} 2 π f} for {f}_{M} < f < {f}_{m ′} \qquad ( 6 )$$

The lower the photodiode capacitance Cₚₕ and the higher the transformation ratio, namely n>1, the better the signal-to-noise ratio. This n>1 result is counter-intuitive, as it might be expected that a value of n<1 would have resulted in a better signal-to-noise ratio based on the formula:

$$Is = 1 / n . lp$$

The frequency f_{M} corresponding to the maximum noise gain or the maximum noise spectral density should preferentially be located at a lower value than the lowest frequency of interest fᵢ_{_{b}}. The transformation of the formula expressing f_{M} makes it possible to set:

$$L > \frac{{n}^{2} {L}_{p}}{{L}_{p} {{C}_{ph} ( 2 π {f}_{i\_b} )}^{2} - 1} \qquad ( 7 )$$

The value of L should also be minimized to maintain a high signal gain, according to the established expression (5). A good compromise is:

$$\frac{{n}^{2} {L}_{p}}{{L}_{p} {{C}_{ph} ( 2 π {f}_{i\_b} )}^{2} - 1} < L < 10. \frac{{n}^{2} {L}_{p}}{{L}_{p} {{C}_{ph} ( 2 π {f}_{i\_b} )}^{2} - 1}$$

Values outside this range will lead to sub-optimal operation of the assembly: reduced signal-to-noise ratio or reduced signal gain.

The values of the primary and secondary inductors Lₚ and Lₛ, respectively, are linked by the transformation ratio n through:

$${n}^{2} = \frac{{L}_{s}}{{L}_{p}}$$

For optimum operation, L should be close to Ls, so as not to lower the signal gain too much. Preferentially, 0.5 Ls<L<2 Ls.

With the condition L=Lₛ=n²Lₚ, condition (3) implies:

$$C > \frac{1}{2 {n}^{2}} {C}_{ph} \qquad ( 8 )$$

Too low a value of f_{LC} would lead to a rise in noise gain at low frequencies (long-term noise), which could also lead to TIA saturation. In practice, it has been established by the inventors that a preferential range of choice for C is:

$$\frac{10}{{n}^{2}} {C}_{ph} < C < \frac{500}{{n}^{2}} {C}_{ph} \qquad ( 9 )$$

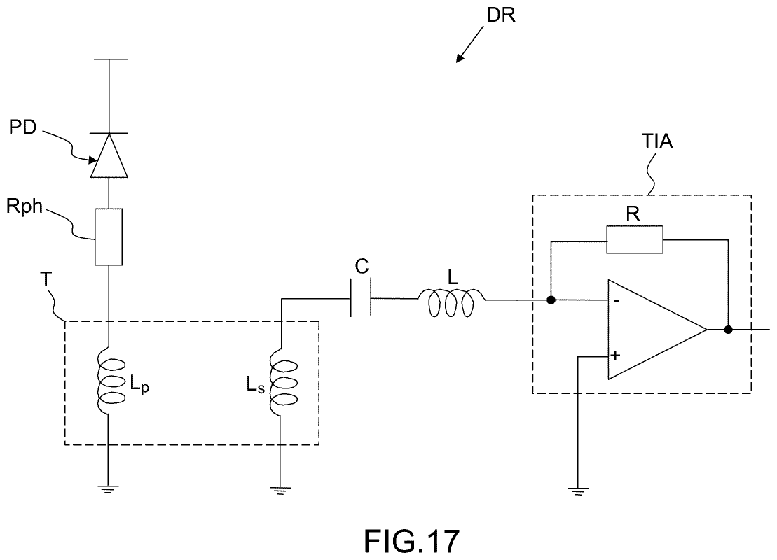

The amplification circuit AC shown in the figure has several resonance modes, resulting in a pseudo-oscillating impulse response. These pseudo-oscillations pose no problem when the lidar processing unit features a module that performs suitable processing, transforming these oscillations into suitable signals. For other lidar applications that do not include a TF module, these oscillations can be a nuisance. According to an embodiment shown in FIG. 17, the reception device DR according to the invention also includes a resistor, known as a damping resistor Rph, placed in series with the photodiode PD, which dampens oscillations. Since the resistor Rph adds noise and causes a voltage drop across the static currents flowing through it, the minimum value must be chosen to achieve the desired effect while minimizing it. Typically, this resistor Rph ranges from a few ohms to a few hundred ohms.

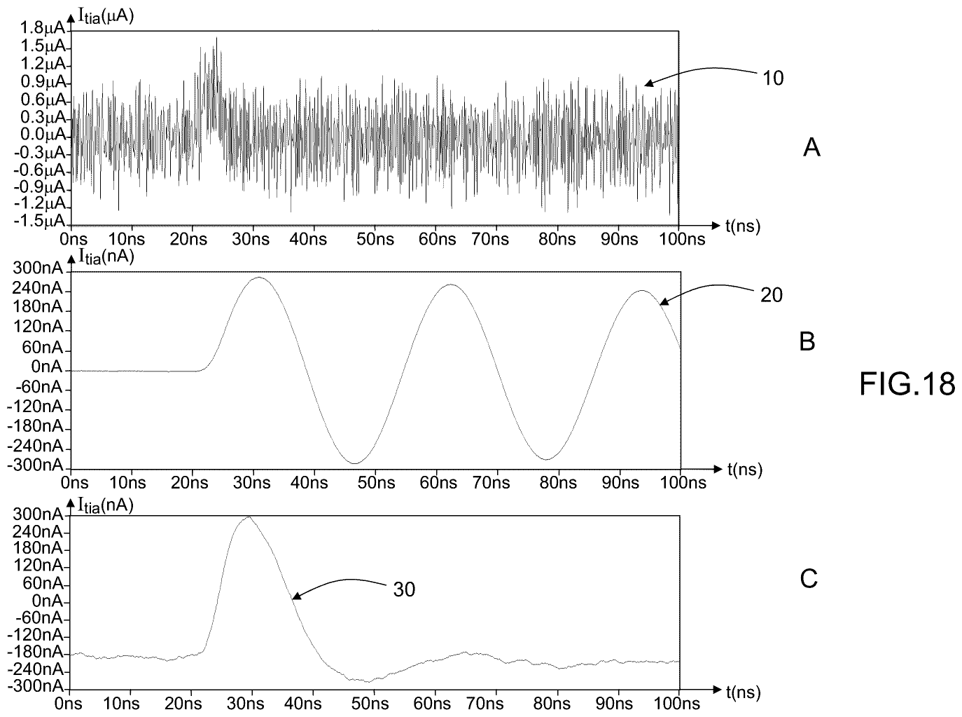

FIG. 18 shows various simulated signals. For the simulation, we have:
L=Ls, n=4, C=62 pF, Ls=80 μH, Cph=10 pF, R=500Ω
   Optical pulse: duration 6 ns-5 μW-delay 20 ns

The transimpedance amplifier TIA is considered with an infinite band-gain product, and the noise source is eₙ=4 nV/\sqrt{Hz}.

In FIG. 18A: the signal 10 is equal to Itia with an amplification circuit comprising the transformer, a capacitor but no inductor. The signal is still noisy.

In FIG. 18B: the signal 20 is equal to Itia with an amplification circuit comprising a capacitor and an inductor. The signal is now very clean and usable for lidar detection.

In FIG. 18C: the signal 30 is equal to Itia with an amplification circuit comprising a capacitor, an inductor and a damping resistor Rth of 500Ω. The oscillation has all but disappeared.

The echo pulse reception time (20 ns) is determined by a series of processing operations (not detailed here) performed on signals 20 or 30.

1-8. (canceled)

9. A system based on measuring a time of flight, comprising:
an emission device configured to emit light pulses toward a scene at an angle greater than or equal to 5°
a reception device comprising:
a photodetector configured to receive pulses reflected or backscattered by at least one element of the scene and to convert said pulses into an electrical signal,
an amplification circuit configured to amplify said electrical signal,
a processing unit for processing said amplified electrical signal, configured to digitize the amplified electrical signal and determine a distance from said at least one element based on said digitized amplified electrical signal.
the amplification circuit comprising a transimpedance amplifier, a transformer comprising a primary and a secondary, a capacitor and an inductor arranged in series with said capacitor, the primary of the transformer being connected to an anode of the photodetector, the secondary being connected to said capacitor, said capacitor being connected to an input of said transimpedance amplifier.

10. The lidar system according to the claim 9, wherein a frequency operating range of the transformer includes the [10 MHz; 350 MHz] band.

11. The lidar system according to claim 9, wherein a transformation ratio equal to the ratio of the number of turns of the secondary to the number of turns of the primary is strictly greater than 1.

12. The lidar system according to claim 9, wherein the capacitor C and the inductor L satisfy the relationship:
$$( L + {n}^{2} {L}_{p} ) C > {L}_{p} {C}_{ph}$$
with Lₚ the transformer primary inductance, Cₚₕ the photodiode transition capacitance, n the transformation ratio defined by:
$$\frac{{n}_{s}}{{n}_{p}} = n$$
with nₚ and nₛ the number of primary and secondary turns, respectively.

13. The lidar system according to claim 9, wherein the inductor satisfies the relationship:
$$L > \frac{{n}^{2} {L}_{p}}{{L}_{p} {{C}_{ph} ( 2 π {f}_{i\_b} )}^{2} - 1}$$
where:
$$\frac{{n}_{s}}{{n}_{p}} = n$$
with nₚ and nₛ the number of primary and secondary turns, respectively,
Lₚ the inductor of the primary of the transformer, Cₚₕ the photodiode transition capacitance, f_{i_b} the minimum frequency of interest.

14. The lidar system according to claim 9, wherein the inductor satisfies the relationship:
0.5 Ls<L<2 Ls
where L is the inductor and Ls is the secondary inductor of the transformer

15. The lidar system according to claim 9, wherein the capacitor C satisfies the relationship
$$\frac{10}{{n}^{2}} {C}_{ph} < C < \frac{500}{{n}^{2}} {C}_{ph}$$
with Cph the photodiode transition capacitor.

16. The lidar system according to claim 9, wherein the reception device further comprises a so-called damping resistor (Rph) between the photodetector and the transformer primary.
